(19) United States
(12) Patent Application Publication
(10) Pub. No.: US 2004/0214910 A1
(43) Pub. Date: Oct. 28, 2004

(54) FOAM PLASTIC FROM DISPOSABLE PRESSURIZED CONTAINERS

(76) Inventors: HERMANN KLUTH, DUESSELDORF (DE); WOLFGANG KLAUCK, MEERBUSCH (DE); PETER DAUTE, BEVERSTEDT (DE); FELICITAS KOLENDA, MONHEIM (DE); WILFRIED HUEBNER, LANGENFELD (DE)

Correspondence Address: HENKEL CORPORATION, THE TRIAD, SUITE 200, 2200 RENAISSANCE BLVD., GULPH MILLS, PA, 19406, US

(21) Appl. No.: 08/702,625

(22) PCT Filed: Feb. 16, 1995
(86) PCT No.: PCT/EP95/00566

(30) Foreign Application Priority Data
Feb. 24, 1994 (DE) P4405983.3
Oct. 24, 1994 (DE) P4441696.2

(51) Int. Cl. C08G 18/10; B67D 5/56; B67D 5/60; B67D 5/64; B65D 5/72; B65D 83/14; B67D 5/58

(52) U.S. Cl. 521/159; 222/129; 222/130; 222/190; 222/491; 222/635

(57) ABSTRACT

A composition useful for the production of foam plastics from disposable pressurized containers is provided. The composition comprises at least one polyisocyanate or isocyanate prepolymer, at least one catalyst for the reaction of the isocyanate group with the OH group, at least one blowing agent and at least one foam stabilizer. One day at the latest after application from said disposable pressurized container, the residue of said composition left in the pressurized container has a diisocyanate monomer content of less than 5.0% by weight, based on the residual contents of the emptied container.

This invention relates to a composition for the production of foam plastics from disposable pressurized containers, to the foam plastics themselves and to their use.

Foam plastics are materials of cellular structure, for example of PU, PS, PE or PVC. They are formed either by pressureless foam generation (for example mechanical) or by the sudden expansion of polymers or prepolymers containing a gas (for example a liquefied gas). If the foam plastic is produced at the point of use, it is known as an in situ foam (DIN 18159). One particular form of in situ foams are moisture-curing one-component systems. The composition to be foamed is accommodated in pressurized containers, above all in disposable pressurized containers (aerosol cans), because they are easy to handle. In situ foams of polyurethane are used above all in the building industry for sealing, insulation and assembly purposes, for example in connection with joints, roof surfaces, windows and doors.

The production of polyurethane foam plastics from disposable pressurized containers is known. An isocyanate prepolymer is prepared by reaction of polyols with organic diisocyanates and/or polyisocyanates in the presence of a foam stabilizer and catalyst and, optionally, plasticizers, flameproofing agents and other additives. This reaction takes place in the presence of liquefied gas in a pressurized container. After formation of the prepolymer, the foam can be discharged in measured quantities through a valve. The foam has a creamy consistency and cures under the effect of ambient moisture, for example from the air, undergoing an increase in volume in the process (one-component foam). An activator may also be added from another pressurized container immediately before application of the foam. The activator provides for faster tack-free curing of the foam (two-component foam). The activator may be a short-chain diol, for example ethylene glycol, propylene glycol, butane-1,4-diol or glycerol.

A starting product made up in this way for the production of one-component polyurethane foams is described in DE 40 25 843, the mixture containing a prepolymer with a dynamic viscosity of 200 to 4,000 mPa·s, as measured at 20° C., and an NCO group content of 13 to 15% by weight. In this case, too, the prepolymer is formed in an aerosol can. In DE 39 11 784 also, the prepolymer is similarly prepared either in the aerosol can itself or in another pressurized container.

A critical factor is the composition of the NCO prepolymer. This is because, almost without exception, it is prepared in the pressurized containers themselves from mixtures of technical diphenylmethane-4,4′-diisocyanate (MDI) with an average functionality of 2.3 to 2.7 and polyols with an average functionality of 2.5 to 3.5 in an NCO:OH ratio of 3 to 10 and preferably 4 to 6:1 in the presence of a tertiary amine as catalyst. In view of the excess of MDI, unreacted MDI is still present in a large quantity of the order of 7 to 15% by weight, based on the total contents of the pressurized container. In view of this content of monomeric MDI, the compositions have to be labeled as “of low toxicity, contains diphenylmethane-4,4′-diisocyanate” and provided with the “St. Andrew's cross” danger symbol. If, instead of MDI, more readily volatile polyisocyanates were to be used to prepare the prepolymer, the reaction mixtures would also contain relatively large quantities of unreacted diisocyanate. Under the law on hazardous materials, these products would even have to be labeled as “toxic” and provided with the “death's head” danger symbol. In view of their high toxicity, diisocyanates of the type in question are not used in insulating and assembly foams from aerosol cans. In addition, the cure times of prepolymers of aliphatic or cycloaliphatic diisocyanates are too long for use as one-component assembly and insulating foams. Accordingly, only MDI is in fact used for this purpose.

The foam plastics produced from the prepolymers are not a problem because the free MDI reacts with water and is thus firmly attached as a urea unit to the crosslinked polyurethane.

By contrast, the disposal of residues of such prepolymers in the disposable pressurized containers is problematical. Under current waste disposal laws in Germany, they have to be disposed of as special waste. The costs involved in their disposable are constantly increasing in view of the limited space available. Accordingly, there is a need for assembly and insulating foams of which the residues or waste are easy to dispose of.

The diphenylmethane-4,4′-diisocyanate (MDI) vapors emitted during the foaming process are also problematical. On account of these vapors, MDI-containing formulations have to be labeled as “damaging to health if inhaled; irritates the eyes, respiratory organs and the skin; sensitization by inhalation possible”. Since the maximum workplace concentration of MDI was reduced originally from 0.02 mg/m³ to 0.01 mg/m³ and recently to 0.005 mg/m³, the maximum workplace concentration can easily be exceeded by large-scale users. In order to avoid the resulting dangers, elaborate precautionary measures then have to be taken. Accordingly, there is a need for assembly and insulation foams which show a considerably reduced emission of diphenylmethane diisocyanate during processing.

Another problem lies in the fire properties of PU foams. In building applications, they have to meet certain standards in most countries, for example DIN-4102-B2 in Germany (normal inflammability). Large additions of flameproofing agents containing phosphorus, chlorine and bromine are required for this purpose. Additives such as these can be non-reactive, such as tris(chloropropyl) phosphate for example, or even reactive, such as tetrabromobisphenol A. When correspondingly flameproofed PU foams are exposed to fire, toxic gases, such as HCl, HBr, etc., are given off. Smoke gas density is another criterion for acceptability. In view of the large additions of flameproofing agents in standard one-component PU foams based on polyether polyols or oleochemical polyols (the content is generally 20 to 25% by weight, based on the contents of the can, large quantities of toxic gases are given off and the smoke gas density is correspondingly high. Accordingly, there is a need for foams which do not contain any bromine compounds as flameproofing agents and, in addition, no chlorine-containing flameproofing agents. They should have at best a minimum content of halogen-free phosphorus-containing flameproofing agents.

It would be logical to produce the assembly and insulating foams from other polymers than PU, for example from polystyrene.

Accordingly, there has been no shortage of attempts to use low-monomer NCO prepolymers for the production of PU foam plastics. DE 44 05 983 describes PU foams containing cyclotrimers of hexamethylene-1,6-diisocyanate as their main component. However, the compositions mentioned therein are extremely expensive and are complicated to produce.

The solution provided by the invention is that, 24 hours after foaming at the latest, the residue of the composition containing the isocyanate prepolymer as reactive component remaining in the pressurized container has a content of diisocyanate monomers of less than 2.0% by weight, more particularly less than 1.0% by weight and, above all, less than 0.5% by weight, based on the composition. These values are preferably reached after only 2 hours or even after 0.5 hour.

The composition best has a correspondingly low content of diisocyanate monomers before the foaming reaction.

This can be achieved with advantage if the prepolymer has correspondingly low diisocyanate contents before the foaming reaction, for example because it has been distilled. However, it can also be of advantage to polymerize the diisocyanate monomers by addition of trimerization catalysts immediately before or after foaming. In the case of one-component systems, it is also possible to add an OH compound, more particularly a monoalcohol, to the composition remaining behind after foaming.

The composition necessarily consists of at least one isocyanate prepolymer, at least one catalyst for the reaction of the isocyanate group with the OH group, at least one blowing agent and at least one foam stabilizer. In addition, other additives, for example solvents, flameproofing agents, plasticizers, cell regulators and antiagers, may also be added.

In the context of the invention, an “isocyanate prepolymer” is an oligomer containing reactive NCO groups which is involved as a pre-adduct in the formation of the polymer. The isocyanates are preferably aliphatic diisocyanates containing 2 to 36 carbon atoms and, more particularly, 4 to 7 carbon atoms or cycloaliphatic diisocyanates containing 5 to 30 carbon atoms and, more particularly, 8 to 15 carbon atoms. However, aromatic diisocyanates containing 8 to 20 and, more particularly, 8 to 11 carbon atoms may also be used. The diisocyanates should boil at the latest at 180° C. under a pressure of 10 mbar. Specific examples of suitable diisocyanates are hexamethylene diisocyanate (HDI), tetramethylene diisocyanate (TMDI), isophorone diisocyanate (IPDI), tolylene-2,6-diisocyanate (TDI), tolylene-2,4-diisocyanate (2,6-TDI), m-tetramethyl xylene diisocyanates (m-TMXDI), p-tetramethylxylene diisocyanates (p-TMXDI), trimethyl hexamethylene diisocyanate (TMDI), dimeryl diisocyanate (DDI), p-phenylene diisocyanate (PPDI), naphthylene-1,5′-diisocyanate (NDI), diphenylmethane-4,4′-diisocyanate (MDI), tolidine diisocyanate (TODI), bis-(4-isocyanatocyclohexyl)-methane (H12-MDI), 3(4)-isocyanatomethyl-1-methyl cyclohexyl isocyanate (IMCI), phenyl isocyanate and ester isocyanates of isocyanatocarboxylic acid chlorides and silylated polyalcohols (see Mormann: Tetrahedron Letters 28 (1987), 3087 et seq. and Mormann: Makromol. Chem., Makrom. Symp. 25 (1989) 117 et seq.).

Among the diisocyanates, those of which the NCO groups differ in their reactivity are preferred. They enable low-monomer prepolymers to be produced from polyols without distillation. Corresponding diisocyanates are, for example, isophorone diisocyanate and 2,4-tolylene diisocyanate. Preferred prepolymers are prepolymers of IPDI with TMP (trimethylol propane) providing they have been produced with a low monomer content. One process for the production of polyurethane prepolymers with a low residual monomer content is described in EP 0 150 444. According to this document, the diisocyanate is reacted with a polyhydric alcohol in an OH:NCO ratio of 4 to 0.55:1 in a first reaction step. After virtually all fast NCO groups have partly reacted off with the OH groups present, a more reactive diisocyanate—compared with the less reactive NCO groups of the isocyanate used in reaction step I—is added in an equimolar quantity or in a small excess, based on free OH groups, in a second reaction step. If desired, catalysts may be added or higher temperatures applied. The disclosure of EP 0 150 444 is hereby specifically included as part of the present application.

The diisocyanates may be replaced by up to 40 mole-% and, more particularly, 20 mole-% of monoisocyanates or triisocyanates. Phenyl isocyanate is a specific example.

Isocyanate prepolymers can be prepared from the diisocyanates without any other reactive components by trimerization to isocyanurates. This reaction is known to take place in the presence of suitable trimerization catalysts (see, for example, Kunststoff-Handbuch, Vol. 7, Polyurethane, page 108). Mixtures of cyclotrimers of aliphatic and cycloaliphatic diisocyanates, more especially mixed trimers thereof, are of particular advantage.

However, the isocyanate prepolymers may even be prepared by reaction of diisocyanates with polyols in the presence of suitable catalysts. Suitable catalysts are those which accelerate the reaction of the isocyanate group with the OH group, but not the trimerization thereof. Specific examples are 2,2′-dimorpholinodiethyl ether, bis-(2-dimethylaminoether) ether, Dabco X-DM (Air Products) and N-ethyl morpholine. In some cases, however, other catalysts may also be used providing they do not trimerize the isocyanate groups in storage, for example N-substituted morpholines and mixtures thereof with propylene oxide adducts of triethanolamine and the known metal catalysts, particularly tin.

The polyols used to produce the prepolymers may be any of the usual long-chain or short-chain hydroxyfunctional polyesters and polyethers.

The short-chain polyols are used in a quantity of 0 to 0.5 HO equivalents per NCO group and, more particularly, in a quantity of 0.1 to 0.3 HO equivalents per NCO group. They have a molecular weight below 1,000 and, more particularly, below 100. Specific examples are the polyols which are used as starting compounds for the production of the long-chain polyols.

Suitable polyesters are esters of dicarboxylic acids, preferably aliphatic dicarboxylic acids containing 4 to 8 carbon atoms in the alkylene group, which are reacted with polyhydric alcohols, preferably diols, which must also contain free OH groups for the reaction. Examples of aliphatic dicarboxylic acids are pimelic acid, glutaric acid, azelaic acid, sebacic acid and, preferably, succinic acid and adipic acid and aromatic dicarboxylic acids, such as phthalic acid, isophthalic acid and terephthalic acid. Suitable dihydric or polyhydric alcohols are ethylene glycol, diethylene glycol, 1,2- and 1,3-propylene glycol, triethylene glycol, dipropylene glycol, glycerol, trimethylol propane, butane-1,4-diol and hexane-1,6-diol.

However, it is also possible to use polyester polyols of oleochemical origin which do not contain any free expoxy groups and which have been produced by complete ring opening of epoxidized triglycerides of a fatty acid mixture containing at least partly olefinically unsaturated fatty acid with one or more alcohols containing 1 to 12 carbon atoms and subsequent partial transesterification of the triglyceride derivatives to alkyl ester polyols containing 1 to 12 carbon atoms in the alkyl group (see DE 36 26 223).

Suitable polyethers are any of the products obtained in known manner from one or more alkylene oxides containing 2 to 4 carbon atoms in the alkylene group and a starter molecule containing 2 to 4 active hydrogen atoms. Suitable alkylene oxides are, for example, tetrahydrofuran, 1,3-propylene oxide, 1,2- to 2,3-butylene oxide and ethylene oxide. Suitable starter molecules are water, dicarboxylic acids, polyhydric alcohols, such as ethylene glycol, propylene-1,2-glycol, diethylene glycol, dipropylene glycol, glycerol, trimethylol propane, pentaerythritol, sorbitol and sucrose and also aminofunctional compounds. Other polyols are polycarbonate polyols and dimer diols (Henkel KGaA).

The isocyanate polymers are produced in known manner from the diisocyanates and the polyols. To produce low-monomer isocyanate prepolymers, the volatile isocyanates present in excess are distilled off in vacuo at temperatures of 100 to 160° C. using a thin-layer evaporator or short-path evaporator. Further particulars of the production of low-monomer isocyanate prepolymers by distillation can be found, for example, in DE 41 40 660 which describes the production of ether and urethane polyisocyanates based on polyhydroxypolyethers and tolylene diisocyanate which have an NCO content of 11.8 to 14.4% by weight, an average NCO functionality of 3.1 to 4.0 and a free tolylene diisocyanate content of less than 0.1% by weight. The disclosure of this document is hereby specifically included as part of the present application where it relates to the production of the prepolymers. By contrast, the use of the prepolymers disclosed in the document in question for the production of polyurethane lacquers is not included.

The production of certain polyadducts of TDI with minimum residual monomer contents of 0.2% is also described in DE 15 95 273 and U.S. Pat. No. 4,128,825. In this case, too, the production of these polymers is specifically included in the present application.

Of the two methods of producing low-monomer isocyanate prepolymers, distillation is preferred to production with differently reactive diisocyanate groups. The result of this is that the prepolymers can be produced outside rather than in the pressure vessel, as had hitherto been the case.

The following observation is of particular importance:

If technical mixtures of MDI with functionalities of more than 2.7, for example Desmodur vp-pu-1194, are used to produce the prepolymer, highly viscous, non-processable products are obtained through the formation of crosslinked gel components or high molecular weight species. It has now been found that, contrary to established knowledge, foam plastics can be produced from technical MDI providing the difunctional isocyanates are removed so that, essentially, only molecules containing at least three isocyanate groups, preferably 3 to 10 isocyanate groups, and the corresponding aromatic rings are present (polymer-MDI).

This polymer-MDI is produced from technical MDI with a functionality of more than 2.3, more particularly in the range from 2.4 to 2.7 and preferably of the order of 2.7 by removal of the monofunctional and difunctional isocyanates. Thin-layer or short-path distillation in vacuo or extraction and fractional crystallization are suitable for the removal of the monofunctional and difunctional isocyanates. The diisocyanate content should be reduced to below 20% by weight, preferably to below 10% by weight and more preferably to below 5% by weight (HPLC). The viscosity of the polymer-MDI is in the range from 5 to 2,000 Pa·s at 25° C. and preferably in the range from 20 to 500 Pa·s at 25° C., as measured in accordance with DIN 53015.

If the viscosity of the polymer-MDI should be too low, which is generally the case below 5,000 mPa·s, the polymer-MDI is reacted with diols to form a polymer-MDI prepolymer.

A “polymer MDI prepolymer” in the context of the invention is an oligomer containing reactive NCO groups which, as a preadduct of the polymer-MDI and at least one polyol, more especially a diol, is involved in the formation of the polymer. The polymer-MDI is preferably a polymer-MDI with a viscosity of >10,000 mPa·s at 25° C. The polyols used may be any of the hydroxyfunctional polyesters and polyethers (long-chain polyols) with a functionality of >1 to 3, more especially 2, typically used for the production of the prepolymers and also short-chain diols.

The polyester diols used may be esters of dicarboxylic acids, preferably aliphatic dicarboxylic acids containing 4 to 8 carbon atoms in the alkylene group, which are reacted with diols which must also contain free OH groups for the reaction. Examples of aliphatic dicarboxylic acids are pimelic acid, glutaric acid, azelaic acid, sebacic acid and, preferably, succinic and adipic acid and aromatic dicarboxylic acids, such as phthalic acid and terephthalic acid. Suitable dihydric alcohols are ethylene glycol, diethylene glycol, 1,2- and 1,3-propylene glycol, dipropylene glycol, butane-1,4-diol and hexane-1,6-diol.

However, it is also possible to use polyester polyols of oleochemical origin which do not contain any free epoxy groups and which have been produced by complete ring opening of epoxidized triglycerides of a fatty acid mixture containing at least partly olefinic unsaturated fatty acids with one or more alcohols containing 1 to 12 carbon atoms and subsequent partial transesterification of the triglyceride derivatives to alkyl ester polyols containing 1 to 12 carbon atoms in the alkyl group (see DE 36 26 223).

The polyether diols used may be the products produced in known manner from one or more alkylene oxides containing 2 to 4 carbon atoms in the alkylene group and a starter molecule containing two active hydrogen atoms. Suitable alkylene oxides are, for example, tetrahydrofuran, 1,3-propylene oxide, 1,2- to 2,3-butylene oxide and ethylene oxide. Suitable starter molecules are water, dicarboxylic acids, polyhydric alcohols, such as ethylene glycol, 1,2-propylene glycol, diethylene glycol, dipropylene glycol and dimer diols (Henkel KGaA).

The long-chain diols of the above-mentioned structural elements have a molecular weight of more than 1,000 and, more particularly, in the range from 2,000 to 6,000 (gel chromatography). They are added in a quantity of 0 to 0.7 and preferably 0.2 to 0.5 HO equivalents per NCO group.

The short-chain diols are used in a quantity of 0 to 0.5 and, more particularly, 0.1 to 0.3 HO equivalents per NCO group. They have a molecular weight below 1,000 and, more particularly, below 100. Specific examples are the diols used for the production of the long-chain diols.

The polymer MDI prepolymer may also be produced from polymer-MDI and compounds containing other NCO-reactive groups than the HO group, for example the COOH, SH, NH₂ or NH group. The functionality is preferably from 1.5 to 2.5 and, more particularly, 2.

The polymer-MDI prepolymers are produced in known manner from the diisocyanates and the diols. The catalysts used are catalysts which accelerate the reaction of the isocyanate group with the OH group, especially with water, but not the trimerization thereof. Specific examples are 2,2′-dimorpholinodiethyl ether, bis(2-dimethylaminoethyl) ether, Dabco X-DM (Air Products) and N-ethyl morpholine. In some cases, however, other catalysts may also be used providing they do not trimerize the isocyanate groups in storage, for example N-substituted morpholines and mixtures thereof with propylene oxide adducts of triethanolamine, and the known metal catalysts, especially tin.

Irrespective of the method used for their production, the reactive isocyanate-containing components based on MDI are characterized by the following features. They have a diisocyanate content of less than 20% by weight, more especially less than 10% by weight and, above all, less than 5% by weight, based on the reactive component. They have an NCO functionality of 2.7 to 5 and, more particularly, 2.8 to 4 and an NCO content of 26.0 to 30.0% by weight and, more particularly, 27.0 to 29.0% by weight, based on the reactive component, and a viscosity of 5 to 200 and, more particularly, 10 to 100 Pas at 25° C., as measured in accordance with DIN 53015.

The other polyisocyanates and isocyanate prepolymers are characterized by the following features, irrespective of the method used for their production. They have an isocyanate monomer content of less than 3.0% by weight, more particularly less than 1.0% by weight and, above all, less than 0.5% by weight, based on the prepolymer. They have an NCO functionality of 2 to 5 and, more particularly, 2.5 to 4.2 and an NCO content of 8 to 30% by weight and, more particularly, 10 to 23% by weight, based on the prepolymer, and a viscosity of 5 to 200 Pas and, more particularly, 10 to 100 Pas at 25° C., as measured in accordance with DIN 53015. The prepolymers are preferably produced from aliphatic diisocyanates containing 2 to 12 and preferably 4 to 8 carbon atoms and from cycloaliphatic isocyanates containing 5 to 30 and preferably 7 to 12 carbon atoms. In addition, however, aromatic diisocyanates containing 8 to 20 carbon atoms may also be used. The boiling point of the diisocyanates should be at most 180° C. and is preferably at most 160° C. at 10 mbar.

The composition according to the invention for the production of foam plastic necessarily consists of at least one polyisocyanate or isocyanate prepolymer, at least one catalyst for the reaction of the isocyanate group with the OH group, more especially with water, at least one blowing agent and at least one foam stabilizer. Other additives may also be incorporated, including for example solvents, flameproofing agents, plasticizers, cell regulators and antiagers. A solution or emulsion is formed.

2,2′-Dimorpholinodiethyl ether or bis(2-dimethylaminoethyl) ether is preferably used as the catalyst. It should only catalyze the reaction of the NCO group with OH groups, but not the trimerization thereof in storage.

1,1,1,2-Tetrafluoroethane, 1,1-difluoroethane and dimethyl ethane is preferably used as blowing agent. However, n-propane, n-butane and isobutane may also be used.

Siloxane/hydroxyalkylene copolymers, for example Tegostab B 8404 (Goldschmidt) or Dabco DC-190, DC-193 (Air Products), are preferably used as the foam stabilizer.

Preferred plasticizers are tris(2-chloropropyl) phosphate, tris(chloroethyl) phosphate, diphenyl cresyl phosphate, dimethyl methyl phosphonate (DMMP) and diethyl ethyl phosphonate (DEEP).

In quantitative terms, the contents of the pressurized containers are preferably as follows (in % by weight):

50 to 90 and preferably 60 to 85 of the isocyanate component,

0.1 to 5.0 and preferably 0.5 to 20 of catalysts,

5 to 35 and preferably 10 to 25 of blowing agents and

0.1 to 5.0 and preferably 0.5 to 3.0 of foam stabilizer,

0 to 20 and preferably 3 to 15 of plasticizer.

Of the optional additives, the flameproofing agent may be added in a quantity of 2 to 50% by weight and preferably 5 to 15% by weight. The other optional additives may be added in a quantity of 0.1 to 3.0% by weight and, more particularly, 0.2 to 1.5% by weight, based on the composition as a whole.

In addition to these compositions with their very low diisocyanate content, typical compositions with the usual isocyanate contents may also be used providing at least one trimerization catalyst additionally capable of accelerating the moisture curing process is added to them immediately before use (foaming). Specific examples of such catalysts are dibutyl tin dilaurate, potassium acetate, potassium-2-ethyl hexoate, N,N-dimethyl cyclohexylamine and tris-2,4,6-(dimethylaminomethyl)-phenol. Accordingly, not only is the curing of the foam accelerated, the NCO prepolymer and monomers are also converted into the polymeric isocyanurate in the container over a period of one day. Thereafter, the residual reaction mixture contains hardly any more monomeric diisocyanate. After this reaction, the pressurized gas packs can be disposed of and recycled in the same way as usual packs because they may be regarded as no longer dangerous after 24 hours at the latest.

The trimerization catalyst has to be stored separately from the rest of the composition, being added and mixed therewith immediately before foaming. Aerosol packs suitable for this purpose are known (see, for example, EP 0 024 659 or DE 36 10 345).

To be sure that the amine catalyst and the composition are sufficiently mixed, it is best to add the amine catalyst together with a dye and/or pigment. If the mixture has not been mixed completely, if at all, the foam is uneven in color or is not colored at all.

In another embodiment of the invention, the normal catalyst required for moisture curing is actually added during filling of the cans. After the can has been emptied, another catalyst is added to the residual quantity of isocyanate prepolymer still present in the pressurized container so that it trimerizes in a short time and is thus converted into a “safe product”, i.e. high molecular weight brittle polyisocyanurates are formed. If low molecular weight monoalcohols, for example ethanol and propanol, are added in excess, plasticizer-like urethanes are formed. If diols with a molecular weight below 400 are added in excess, oligomeric OH-terminated polyurethanes are formed. Both are also safe products.

Pressurized gas packs suitable for this purpose are also known and are used, for example, for two-component polyurethane foams. The trimerization catalysts, the monoalcohol or the diol is preferably released automatically after normal processing of the foam. However, this does require special packs, for example the packs described in EP 446 973 and EP 349 053. It is pointed out by way of example that the pressurized container can accommodate another small pressurized container with the catalyst which empties automatically when the ambient pressure in the large pressurized container has fallen to below 2.5 bar through the removal of foam.

The compositions according to the invention provide for the production of a one-component foam plastic which cures under the effect of ambient moisture in the usual way. However, a two-component foam plastic can also readily be produced providing a polyol is added to the composition in equivalent quantities or in slightly less than the equivalent quantity. The polyol is normally selected from typical polyols containing 2 to 6 carbon atoms and 2 or 3 preferably primary OH groups.

The foam plastic thus produced is particularly suitable for insulation, assembly and sealing in the manufacture of refrigeration equipment, in the transport industry and preferably in the building industry, more especially as an in situ foam.

The invention is illustrated by the following Examples:

### EXAMPLES

### Example 1

A highly viscous adduct with a viscosity of around 10 Pas at 25° C. (DIN 53015) was prepared from 191 g of a commercial cyclotrimer of hexane-1,6-diisocyanate, which has an NCO content of 22.6% by weight (=1 mole NCO) and which is commercially available as Tolonate HDT (Rhone-Poulenc) and Desmodur N 3300 (Bayer AG), by addition of 0.05 mole of ethylene glycol (=0.1 mole OH). 2.0 g of a commercial silicone surfactant available as Tegostab B-8404 (Goldschmidt) and 2.0 g of a catalyst available as Texacat ZF-20 (chemical name: bis(2-dimethylaminoethyl) ether) were added to 96 g of the NCO prepolymer thus prepared and the mixture was introduced into a disposable pressurized container. 25.0 g of dimethyl ether and 10.0 g of 1,1,1,2-tetrafluoroethane (HFKW-134a) were then introduced into the pressurized container which was subsequently shaken until the NCO prepolymer had dissolved in the blowing gas mixture. The monomeric HDI content was <0.1% by weight, based on the composition as a whole.

The dissolved products were then removed from the pressurized container, introduced into a joint measuring 3.0×5.0×50.0 cm at a temperature of 25° C. (room temperature) and at a relative air humidity of 50% and cured therein. The foam formed was characterized by the following data:

| | |
|---|---|
| Tack-free time of the surface: | 10 minutes |
| Full cure time: | 2 hours |
| Foam structure: | fine cells |
| Foam density: | About 24 g/l |
| Hardness of the cured foam: | elastic |

### Examples 2 to 9

In the following Examples, a commercially available IPDI cyclotrimer marketed by Hüls as Vestanate T 1890/100 (NCO content: 17.0 to 17.5% by weight, melting range: 100 to 115° C., monomer content: <0.7% by weight) was used in addition to the HDI cyclotrimer.

| | | Example Number | | | |
|---|---|---|---|---|---|
| | | 2 | 3 | 4 | 5 |
| HDI Trimer | g | 90.0 | 80.0 | 64.0 | 48.0 |
| IPDI Trimer | g | 10.0 | 20.0 | 32.0 | 48.0 |
| Silicone surfactant | g | 2.0 | 2.0 | 2.0 | 2.0 |
| Texacat ZF-20 | g | 2.0 | 2.0 | 2.0 | 2.0 |
| Dimethyl ether | g | 6.5 | 6.5 | 15.0 | 15.0 |
| 1,1,1,2-Tetrafluoro- | g | 19.5 | 19.5 | 10.0 | 10.0 |
| ethane | | | | | |
| Sum | g | 130.0 | 130.0 | 125.0 | 125.0 |
| Tack-free time, mins. | | 9 | 9 | 10 | 10 |
| Cure time, h | | 2 | 2 | 2 | 2 |
| Density, g/l | | 22 | 24 | 24 | 23 |
| Foam hardness | | w/hh | hh | hh | h |
| Dimensional change, % | | <1 | <1 | 20 | <5 |
| Stability in storage⁷⁾ | | >4 | >4 | >4 | >4 |
| at 50° C., w | | | | | |
| | | Example Number | | | |
| | | 6 | 7 | 8 | 9 |
| HDI Trimer | g | 90.0 | 90.0 | 90.0 | 90.0 |
| IPDI Trimer | g | 10.0 | 10.0 | 10.0 | 10.0 |
| Silicone surfactant | g | 2.0 | 2.0 | 2.0 | 2.0 |
| Texacat ZF-20 | g | 2.0 | 2.0 | 2.0 | 2.0 |
| Baysilonol M 100¹⁾ | g | | 0.02 | | |
| Dimethyl ether | g | 6.5 | 6.5 | | |
| 1,1,1,2-Tetrafluoro- | g | 19.5 | 19.5 | | 21.0 |
| ethane | | | | | |
| 1,1-Difluoroethane | g | | | 26.0 | 5.0 |
| Sum | g | 130.0 | 130.0 | 130.0 | 130.0 |
| Tack-free time, mins.²⁾ | | 9 | 9 | 9 | 9 |
| Cure time, h³⁾ | | 2 | 2 | 2 | 2 |
| Density, g/l⁴⁾ | | 23 | 25 | 22 | 25 |
| Foam hardness⁵⁾ | | hh | hh | hh | hh |
| Dimensional change, %⁶⁾ | | >30 | 9 | 15 | 8 |

Legend to the preceding Tables
¹⁾Baysilonöl 100 is a trimethylsiloxy-terminated polydimethyl siloxane with a viscosity of 140 mm²s⁻¹ at 20° C. available from Bayer AG.
²⁾The tack-free time is the time from the beginning of foaming until the foam is no longer tacky.
³⁾The cure time is time from the beginning foaming until the foam can be cut with a knife without residues of the foam adhering to the knife.
⁴⁾Density was measured by the SKZ method.
⁵⁾The hardness of the foam was measured by compression tests in accordance with DIN 53421. The results were evaluated on the basis of the compressive stress at 10% compression. The symbols h, hh and w used in this regard have the following meanings:
h (=hard) at >10 N/cm²
hh (=semi-hard) at 1 to 10 N/cm² and
w (=soft) at <1 N/cm².
⁶⁾The dimensional change was determined by the SKZ method (=Prüf-bestimmungen für Polyurethan-Montageschaumstoff (Tests for Polyurethane Assembly Foam) published by the Süddeutsches Kunststoff-Zentrum in July, 1982).
⁷⁾Stability in storage was determined as follows:
The viscosity of the samples was measured with a rotational viscosimeter (Brookfield RVT, spindle 7, 50 r.p.m., 25° C.). The prepolymer was then stored at 50° C., briefly cooled to 25° C. after one week and its viscosity remeasured. The time required for the initial viscosity to triple is defined as the stability in storage. “w” stands for weeks.
⁸⁾The content of diisocyanate monomers in the prepolymer or rather in the composition is determined by HPLC (high-pressure liquid chromatography).

### Example 10

A. Production of the Low-Monomer Polymer-MDI

800 g of a commercially available technical methylene diphenyl isocyanate (MDI) with a content of around 53% by weight of diphenylmethane diisocyanate (4,4′-; 2,4′-; 2,2′-), a viscosity of around 200 mPas at 25° C., an NCO content of 31.0% by weight and an average functionality of around 2.7 were divided by distillation in a high vacuum (around 0.05 mbar) into two fractions each weighing around 400 g. The bottom temperature was 160 to 210° C. and the vapor temperature around 170° C.

The distillation residue freed from the isomeric diphenyl methane diisocyanates had the following technical data:

| Aggregate state at 20° C.: | highly viscous |
|---|---|
| Viscosity at 50° C. (Pas): | 102 |
| NCO content (% by weight): | 28.0 |
| Diisocyanate content (% by weight): | 2.5 |

The distillate is a mixture of isomeric diphenylmethane diisocyanates which are of no interest to the foams according to the invention.

Moisture-curing resin solutions in aerosol cans are produced from the residue of low-monomer polymer-MDI obtained by distillation by addition of standard non-reactive flameproofing agents, plasticizers, silicone surfactants, catalysts and blowing gases. The foams obtained from this container by expansion were tested for their most important properties.

The compositions (Examples a to c according to the invention and one Comparison Example of a commercially available one-component PU foam) and the test results obtained by foaming and curing in a standard conditioning atmosphere (23° C./50% relative humidity) are set out in the following Table:

| | Example | | | |
|---|---|---|---|---|
| | 10a | 10b | 10c | 10c |
| Polymer-MDI, F = 3.4, 28% NCO | 60 | 60 | 60 | |
| Technical MDI, 31% NCO content, | | | | 40 |
| functionality (F) = 2.5 | | | | |
| Soyapolyol 180¹⁾ | | | | 20 |
| Tris(2-chloropropyl)phosphate | 20 | 10 | 0 | 20 |
| Benzyl butyl phthalate | 0 | 10 | 20 | 0 |
| Siloxane/hydroxyalkylene copolymer | 1 | 1 | 1 | 1 |
| Dimethyl polysiloxane | 0.01 | 0.01 | 0.01 | 0.01 |
| 1,1,1,2-Tetrafluoroethane | 15.0 | 15.0 | 15.0 | 15.0 |
| Dimethyl ether | 5.0 | 5.0 | 5.0 | 5.0 |
| Tack-free time [mins.] | 5 | 5 | 5 | 8 |
| Foam structure | Fine | Fine | Fine | |
| | cells | cells | cells | |
| Density [kg/m³] | 29 | 28 | 28 | 27 |
| Dimensional change [%] | <1 | <1 | <1 | <1 |
| Flame height, max. [cm] | 10.5 | 13.0 | 20.0 | 15.0 |
| (DIN 4102, B2 Test) | | | | |

¹⁾Ring opening product of epoxidized soybean oil with MeOH; OH value 180.

1-14. Cancel

15. An article useful for the production of foam plastics from disposable pressurized containers comprising a disposable pressurized container containing a composition comprising at least one polyisocyanate or isocyanate prepolymer, at least one catalyst for the reaction of the isocyanate group with the OH group, at least one blowing agent and at least one foam stabilizer, wherein one day at the latest after application from said disposable pressurized container, the residue left in the pressurized container has a diisocyanate monomer content of less than 5.0% by weight, based on the residual container containing a composition comprising, at least one polyisocyanate or isocyanate prepolymer having an NCO content of from about 8% to about 30% by weight based on the prepolymer, at least one catalyst for the reaction of an isocyanate group with an OH group, at least one blowing agent and at least one foam stabilizer, wherein not later than one day after application of the plastic foam from said disposable pressurized container, the residue left in the pressurized container has a diisocyanate monomer content of less than 5.0% by weight, based on the residual contents of the emptied container.

16. The system as claimed in claim 15 wherein the diisocyanate monomer content of said composition is less than 2.0% by weight based on the total contents of the container.

17. The system as claimed in claim 16 wherein the diisocyanate monomer content of said composition is less than 2.0% by weight, based on the total contents of the container before application of the composition from said disposable pressurized container.

18. The System as claimed in claim 15 wherein the diisocyanate monomer content of said composition is less than 1.0% by weight based on the total contents of the container.

19. The system as claimed in claim 18 wherein the diisocyanate monomer content of said composition is less than 1.0% by weight based on the total contents of the container before its application from said disposable pressurized container.

20. The system as claimed in claim 15 wherein the diisocyanate monomer contend of said composition is less than 0.5% by weight based on the total contents of the container.

21. The system as claimed in claim 20 wherein the diisocyanate monomer content of said composition is less than 0.5% by weight based on the total contents of the container before application of the composition from said disposable pressurized container.

22. The system as claimed in claim 15 wherein said composition contains, before its application from said disposable pressurized container, as said at least one polyisocyanate or isocyanate prepolymer, at least one isocyanate prepolymer with a diisocyanate monomer content of less than 3.0% by weight, based on the prepolymer, an NCO functionality of 2 to 5, an NCO content of 8 to 30% by weight, based on the prepolymer, and a viscosity of 5 to 200 Pa·s at 25° C., as measured in accordance with DIN 53015, the prepolymer having been produced from at least one diisocyanate selected from the group consisting of aliphatic diisocyanates containing 2 to 36 carbon atoms, cycloaliphatic diisocyanates containing 5 to 30 carbon atoms and aromatic diisocyanates containing 8 to 20 carbon atoms, each with a boiling point not higher than 180° C. at 10 mbar.

23. The system as claimed in claim 22 wherein said at least one isocyanate prepolymer is a cyclotrimer of a diisocyanate.

24. The system as claimed in claim 22 wherein said at least one isocyanate prepolymer is a cyclotrimer of a mixture of hexamethylene diisocyanate, isophorone diisocyanate, and mixed trimers thereof.

25. The system as claimed in claim 22 wherein said at least one isocyanate prepolymer is a prepolymer of diisocyanates or isocyanurates containing NCO groups and polyols.

26. The system as claimed in claim 22 wherein said prepolymer has been produced from diisocyanates with NCO groups differing in their reactivity.

27. The system as claimed in claim 15 wherein said composition is comprised of:
50 to 90% by weight of said at least one polyisocyanate or isocyanate prepolymer,
0.1 to 5.0% by weight of said catalyst,
5 to 35% by weight of said blowing agent, and
0.1 to 5.0% by weight of said foam stabilizer.

28. The system as claimed in claim 15 wherein said at least one polyisocyanate or isocyanate prepolymer is at least one polymer-MDI or polymer-MDI prepolymer with a diisocyanate monomer content of less than 20% by weight, based on the polymer-MDI, an average NCO functionality of greater than 2.7, an NCO content of 26.0 to 30.0% by weight, based on the polymer-MDI, and a viscosity of 5 to 2,000 Pa·s at 25° C. according to DIN 53015, the polymer-MDI being obtained from technical MDI with an average functionality of greater than 2.3 by removal of a portion of the diisocyanatodiphenylmethane.

29. The system as claimed in claim 28 wherein said at least one polymer-MDI or polymer-MDI prepolymer is a prepolymer of the polymer MDI and a polyol.

30. The system as claimed in claim 29 wherein said polyol is a diol containing 2 to 6 carbon atoms.

31. The system as claimed in claim 28 wherein up to 50% by weight of said at least one polymer-MDI or polymer-MDI prepolymer is replaced by at least one member selected from the group consisting of low-monomer NCO prepolymers of hexamethylene diisocyanate, tolylene-2,6-diisocyanate, isophorone diisocyanate, diphenylmethane-4,4′-diisocyanate, and cyclotrimers of aliphatic diisocyanates containing 4 to 14 carbon atoms.

32. The system as claimed in claim 31 wherein said replacing produces moisture-curing foams differing in their hardness and elasticity.

33. The system as claimed in claim 28 wherein said composition is comprised of:
50 to 90% by weight of said at least one polymer-MDI or polymer-MDI prepolymer,
0.1 to 5.0% by weight of the catalyst,
5 to 35% by weight of the blowing agent, and
0.1 to 5.0% by weight of the foam stabilizer.

34. A one-component foam plastic obtained from the claimed in claim 15 by reaction of the composition thereof and moisture.

35. The method of using a one-component foam plastic as claimed in claim 34 wherein said one-component foam plastic is used as an insulating or assembly foam.

36. The method as claimed in claim 35 wherein said one-component foam plastic is used in situ.

37. A two component foam plastic obtained from the article claimed in claim 15 by reaction of the composition thereof as a first component and a polyol as a second component.

38. The method of using a two-component foam plastic as claimed in claim 37 wherein said two-component foam plastic is used as an insulating or assembly foam.

39. The method as claimed in claim 38 wherein said two-component foam plastic is used in situ.

40. A composition for the production of foam plastics from disposable pressurized containers comprising at least one polyisocyanate or isocyanate prepolymer having an NCO content of from about 8% to about 30% by weight based on the prepolymer, at least one catalyst for the reaction of an isocyanate group with an OH group, at least one blowing agent and at least one foam stabilizer, wherein not later than one day after application of the composition from said disposable pressurized container, the residue of said composition left in the pressurized container has a diisocyanate monomer content of less than 5.0% by weight, based on the residual contents of the emptied container.

41. The composition as claimed in claim 40 wherein said composition has a diisocyanate monomer content of less than 2.0% by weight based on the total contents of the container.

42. The composition as claimed in claim 41 wherein the diisocyanate monomer content of said composition is less than 2.0% by weight by weight, based on the total contents of the container before application of the composition from said disposable pressurized container.

43. The composition as claimed in claim 40 wherein said composition has a diisocyanate monomer content of less than 1.0% by weight based on the total contents of the container.

44. The composition as claimed in claim 43 wherein the diisocyanate monomer content of said composition is less than 1.0% by weight, based on the total contents of the container before application of the composition from said disposable pressurized container.

45. The composition as claimed in claim 40 wherein said composition has a diisocyanate monomer content of less than 0.5% by weight based on the total contents of the container.

46. The composition as claimed in claim 45 wherein the diisocyanate monomer content of said composition is less than 0.5% by weight, based on the total contents of the container before application of the composition from said disposable pressurized container.

47. The composition as claimed in claim 40 wherein said composition contains, before application from said disposable pressurized container, as said at least one polyisocyanate or isocyanate prepolymer, at least one isocyanate prepolymer with a diisocyanate monomer content of less than 3.0% by weight, based on the weight of the prepolymer, an NCO functionality of 2 to 5 an NCO content of 8 to 30% by weight, based on the weight of the prepolymer, and a viscosity of 5 to 200 Pa·s at 25° C., as measured in accordance with DIN 53015, the prepolymer having been produced from at least one diisocyanate selected from the group consisting of aliphatic diisocyanates containing 2 to 36 carbon atoms, cycloaliphatic diisocyanates containing 5 to 30 carbon atoms and aromatic diisocyanates containing 8 to 20 carbon atoms, each with a boiling point not higher than 180° C. at 10 mbar.

48. The composition as claimed in claim 47 wherein said at least one isocyanate prepolymer is a cyclotrimer of a diisocyanate.

49. The composition as claimed in claim 47 wherein said at least one isocyanate prepolymer is at least one isocyanate prepolymer selected from the group consisting of cyclotrimer of of hexamethylene diisocyanate, cyclotrimer of isophorone diisocyanate, and mixed trimers thereof.

50. The composition as claimed in claim 47 wherein said at least one isocyanate prepolymer is a prepolymer of at least one of diisocyanates and isocyanurates containing NCO groups and polyols.

51. The composition as claimed in claim 47 wherein said prepolymer has been produced from diisocyanates with NCO groups differing in their reactivity.

52. The composition as claimed in claim 40 wherein said composition is comprised of:
50 to 90% by weight of said at least one polyisocyanate or isocyanate prepolymer,
0.1 to 5.0% by weight of said catalyst,
5 to 35% by weight of said blowing agent, and
0.1 to 5.0% by weight of said foam stabilizer.

53. The composition as claimed in claim 40 wherein said at least one polyisocyanate or isocyanate prepolymer is at least one polymer-MDI or polymer-MDI prepolymer with a diisocyanate monomer content of less than 20% by weight, based on the polymer-MDI, an average NCO functionality of greater than 2.7, an NCO content of 26.0 to 30.0% by weight, based on the polymer-MDI, and a viscosity of 5 to 2,000 Pa·s at 25° C. according to DIN 53015, the polymer-MDI being obtained from technical MDI with an average functionality of greater than 2.3 by removal of the diisocyanatodiphenylmethane.

54. The composition as claimed in claim 53 wherein said at least one polymer-MDI or polymer-MDI prepolymer is a prepolymer of the polymer MDI and a polyol.

55. The composition as claimed in claim 54 wherein said polyol is a diol containing 2 to 6 carbon atoms.

56. The composition as claimed in claim 53 wherein up to 50% by weight of said at least one polymer-MDI or polymer-MDI prepolymer is replaced by at least one low-monomer NCO prepolymer comprising residues of at least one member selected from the group consisting of hexamethylene diisocyanate, tolylene-2,6-diisocyanate, isophorone diisocyanate, diphenylmethane-4,4′-diisocyanate, and cyclotrimers of aliphatic diisocyanates containing 4 to 14 carbon atoms.

57. The composition as claimed in claim 56 wherein said replacing produces moisture-curing foams differing in their hardness and elasticity.

58. The composition as claimed in claims 53 wherein said composition is comprised of:
50 to 90% by weight of said at least one polymer-MDI or polymer-MDI prepolymer,
0.1 to 5.0% by weight of the catalyst,
5 to 35% by weight of the blowing agent, and
0.1 to 5.0% by weight of the foam stabilizer.

59. A one-component foam plastic obtained from the composition claimed in claim 40 by reaction of the composition thereof and moisture.

60. The method of using a one-component foam plastic as claimed in claim 59 wherein said one-component foam plastic is used as an insulating or assembly foam.

61. The method as claimed in claim 60 wherein said one-component foam plastic is used in situ.

62. A two-component foam plastic obtained from the composition claimed in claim 40 by reaction of the composition thereof as a first component and a polyol as a second component.

63. The method of using a two-component foam plastic as claimed in claim 62 wherein said two-component foam plastic is used as an insulating or assembly foam.

64. The method as claimed in claim 63 wherein said two-component foam plastic is used in situ.

65. A method of producing the system as claimed in claim 15 wherein diisocyanate is distilled from said at least one polyisocyanate or isocyanate prepolymer.

66. A method of producing the system as claimed in claim 15 wherein diisocyanate monomers are polymerized by addition of trimerization catalysts immediately before or after foaming.

67. A method of producing the system as claimed in claim 15 wherein diisocyanate monomers are reacted with an OH compound added to the composition remaining in the disposable pressurized container after foaming.

68. The method as claimed in claim 67 wherein said OH compound is a monoalcohol.
